(19) United States
(12) Patent Application Publication
(10) Pub. No.: US 2022/0324262 A1
(43) Pub. Date: Oct. 13, 2022

(54) PNEUMATIC TIRE

(71) Applicant: Toyo Tire Corporation, Itami-shi (JP)

(72) Inventor: Shingo Sano, Itami-shi (JP)

(73) Assignee: Toyo Tire Corporation, Itami-shi (JP)

(21) Appl. No.: 17/713,619

(22) Filed: Apr. 5, 2022

(30) Foreign Application Priority Data
Apr. 7, 2021 (JP) 2021-065467

(51) Int. Cl. B60C 11/03; B60C 11/12

(52) U.S. Cl. CPC B60C 11/0304; B60C 11/1204; B60C 11/1236; B60C 2011/0346; B60C 2011/1213; B60C 2011/0374

(57) ABSTRACT

A pneumatic tire includes a circumferential direction groove extending in a zigzag shape with a first groove part and a second groove part being aligned alternately, a first land part and a second land part. A first lateral groove has a first opening that opens to the first groove part, one groove wall of the first lateral groove is connected to a first land part-side second groove wall demarcating the first land part in the second groove part. A second lateral groove has a second opening that opens to the first groove part and longer than the first opening in the tire circumferential direction, one groove wall of the second lateral groove is connected to a second land part-side second groove wall demarcating the second land part in the second groove part, and the second opening is provided on an extension of the first land part-side second groove wall.

### BACKGROUND OF THE INVENTION

### 1. Field of the Invention

The present invention relates to a pneumatic tire.

### 2. Description of Related Art

A pneumatic tire including a main groove extending in a zigzag shape in a tire circumferential direction has been hitherto known. In such pneumatic tire, traction performance is excellent as the main groove has the zigzag shape; however, drainage performance tends to be reduced.

A pneumatic tire provided with lateral grooves in a land part demarcated by a zigzag-shaped main groove is known as disclosed in JP-2010-105446. Although the drainage performance can be improved by allowing water to pass inside the lateral grooves in such pneumatic tire, further improvement in drainage performance is required.

### SUMMARY OF THE INVENTION

The present invention has been made in view of the above circumstances, and an object thereof is to provide a pneumatic tire with good drainage performance and traction performance.

In pneumatic tire including a circumferential direction groove extending in a tire circumferential direction, a first land part provided on one side in a tire axial direction of the circumferential direction groove, a second land part provided on the other side in the tire axial direction of the circumferential direction groove, a plurality of first lateral grooves provided in the first land part at intervals in the tire circumferential direction, and a plurality of second lateral grooves provided in the second land part at intervals in the tire circumferential direction, the circumferential direction groove extends in a zigzag shape with a first groove part inclined to the tire circumferential direction and a second groove part shorter than the first groove part and inclined to the tire circumferential direction in a reverse direction of the first groove part being aligned alternately, the first lateral groove has a first opening that opens to the first groove part, one groove wall of the first lateral groove is connected to a first land part-side second groove wall demarcating the first land part in the second groove part and extending along the first land part-side second groove wall, the second lateral groove has a second opening that opens to the first groove part and longer than the first opening in the tire circumferential direction, one groove wall of the second lateral groove is connected to a second land part-side second groove wall demarcating the second land part in the second groove part, and the second opening is provided on an extension of the first land part-side second groove wall.

The above pneumatic tire has good drainage performance and traction performance particularly due to the structure of the first lateral groove and the second lateral groove.

### BRIEF DESCRIPTION OF THE DRAWINGS

FIG. 1 is a cross-sectional view of a pneumatic tire according to an embodiment of the present invention;

FIG. 2 is a development view showing a tread pattern of the pneumatic tire of FIG. 1;

FIG. 3 is an enlarged view of a relevant part of the tread pattern of FIG. 2; and

FIG. 4 is a cross-sectional view taken along IV-IV line of FIG. 2.

### DESCRIPTION OF EMBODIMENTS

Hereinafter, an embodiment of the present invention will be explained with reference to the drawings. Respective shapes, dimensions and the like in the specification are values in an unloaded normal state where a tire is fitted to a normal rim and is filled with a normal internal pressure unless specially noted. Examples of the normal rim include the “standard rim” in the JATMA standard, the “Design Rim” in the TRA standard, and the “Measuring Rim” in ETRTO standard. Examples of the normal internal pressure include the “maximum air pressure” in the JATMA standard, the “maximum value” described in “TIRE LOAD LIMITS AT VARIOUS COLD INFLATION PRESSURES” in the TRA standard, and “INFLATION PRESSURE” in the ETRTO standard.

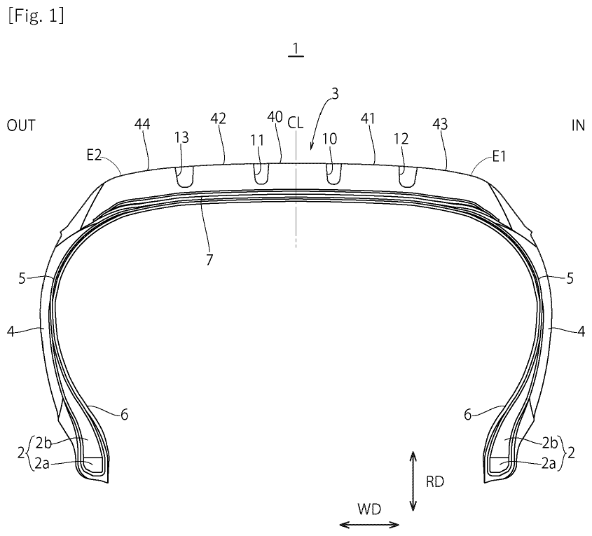

As shown in FIG. 1, beads 2 are provided on both sides in a tire axial direction of a pneumatic tire 1. Each bead 2 includes a bead core 2a formed of steel wire wound in a circular shape and a rubber bead filler 2b provided on an outer side in a radial direction of the bead core 2a. A carcass ply 5 hung across the beads 2 on both sides in the tire axial direction. The carcass ply 5 is a sheet-shaped member in which a large number of ply cords aligned in a direction orthogonal to a tire circumferential direction are coated with rubber. The carcass ply 5 forms a frame shape of the pneumatic tire 1 between the beads 2 on both sides in the tire axial direction. The carcass ply 5 wraps the beads 2 by being folded outwardly from an inner side in the tire axial direction around the beads 2. A sheet-shaped inner liner 6 made of rubber with low air permeability is bonded to the inside of the carcass ply 5.

One or a plurality of belts 7 are provided on an outer side in a tire radial direction of the carcass ply 5. The belt 7 is a member formed of a large number of steel cords coated with rubber. A tread 3 having a grounding surface with respect to a road surface (hereinafter referred to as a “grounding surface”) is provided on the outer side in the tire radial direction of the belt 7. Moreover, sidewall rubbers 4 are provided on both sides in the tire axial direction of the carcass ply 5. In addition to these members, members such as a belt-under pad and a chafer are provided according to functional need of the pneumatic tire 1.

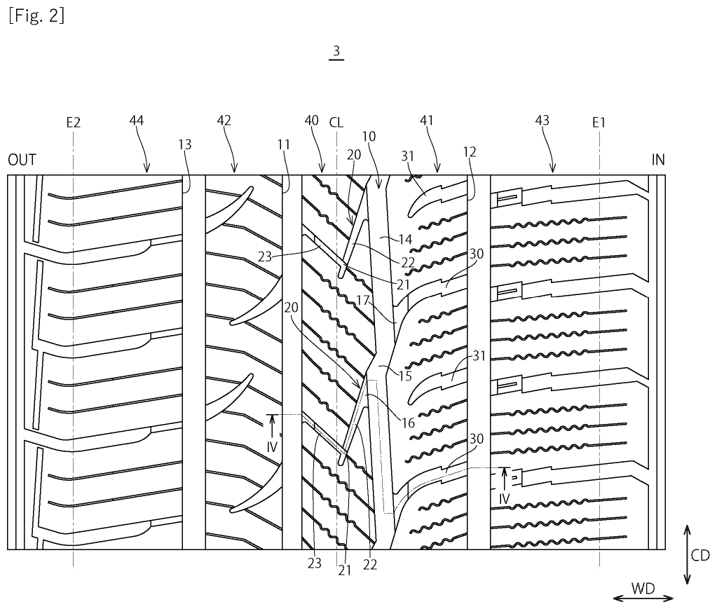

FIG. 2 is a partial development view of the tread 3 of the tire according to the embodiment. In the drawing, a symbol CL denotes a tire equatorial plane corresponding to the center in the tire axial direction. A symbol WD denotes the tire axial direction (also referred to as a tire width direction). An inner side of the tire axial direction WD indicates a direction coming close to the tire equatorial plane CL. An outer side in the tire axial direction WD indicates a direction apart from the tire equatorial plane CL. A symbol CD denotes the tire circumferential direction that is a direction on a circumference about a tire rotation axis. A symbol RD in FIG. 1 denotes the tire radial direction (direction perpendicular to the tire rotation axis). An inner side of the tire radial direction RD is a direction coming close to the tire rotation axis. An outer side of the tire radial direction RD is a direction apart from the tire rotation axis.

The tire according to the embodiment is a tire front and back of which are distinguished when being mounted on a vehicle, that is, a surface facing the outer side and a surface facing the inner side are designated when being mounted on the vehicle. Therefore, markings for designating mounting directions to the vehicle are provided on, for example, sidewalls of the tire. The tire is mounted on the vehicle so that one side in the tire axial direction WD denoted by a symbol OUT faces the outer side (vehicle outer side) in a vehicle-mounted posture and so that the other side in the tire axial direction WD denoted by a symbol IN faces the inner side (vehicle inner side) in the vehicle-mounted posture in FIG. 1 and FIG. 2.

A plurality of main grooves 10, 11, 12, and 13 extending in the tire circumferential direction CD are provided at intervals in the tire axial direction WD on a surface of the tread 3. The main grooves 10, 11, 12, and 13 are generally circumferential direction grooves continuing in the circumferential direction CD with a groove width (opening width) of 5 mm or more.

In this example, four main grooves 10, 11, 12, and 13 are provided on the surface of the tread 3. That is, the first center main groove 10 placed on the inner side of the vehicle with respect to the tire equatorial plane CL, the second center main groove 11 placed on the outer side of the vehicle with respect to the tire equatorial plane CL, the first shoulder main groove 12 placed between the first center main groove 10 and a grounding end E1 on one side in the tire axial direction WD (vehicle inner side), and the second shoulder main groove 13 placed between the second center main groove 11 and a grounding end E2 on the other side in the tire axial direction WD (vehicle outer side) are provided on the surface of the tread 3.

The first center main groove 10 includes a first groove part 14 and a second groove part 15. The first groove part 14 is a groove extending in a straight line inclined toward one side in the tire axial direction WD with respect to the tire circumferential direction. The second groove part 15 is a groove shorter than the first groove part 14 and extending in a straight line inclined in a reverse direction to the first groove part 14 (the other side in the tire axial direction WD) with respect to the tire circumferential direction CD. The first groove part 14 and the second groove part 15 are alternately arranged. Accordingly, the first center main groove 10 has a zigzag shape.

In the first groove part 14, a center land part-side first groove wall 14a demarcating a center land part 40 and a mediate land part-side first groove wall 14b demarcating a first mediate land part 41 are provided in parallel to each other.

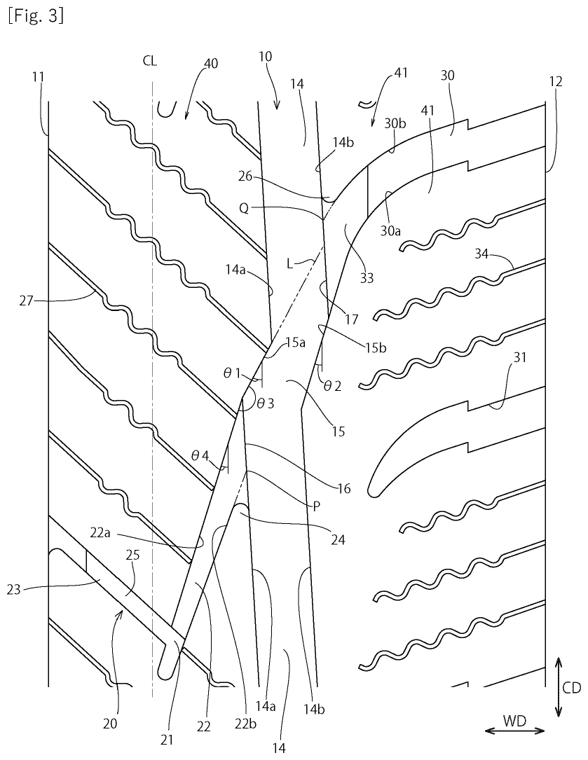

In the second groove part 15, a center land part-side second groove wall 15a demarcating the center land part 40 and a mediate land part-side second groove wall 15b demarcating the first mediate land part 41 are at different angles with respect to the tire circumferential direction CD. In this example, an angle 81 of the center land part-side second groove wall 15a with respect to the tire circumferential direction CD is larger than an angle 82 of the mediate land part-side second groove wall 15b with respect to the tire circumferential direction CD (see FIG. 3).

The second center main groove 11, the first shoulder main groove 12, and the second shoulder main groove 13 are all straight grooves extending in parallel to the tire circumferential direction CD.

A plurality of land parts formed to be demarcated by the main grooves 10, 11, 12, and 13 are provided on the tread 3. Specifically, the center land part 40 demarcated between the first center main groove 10 and the second center main groove 11 is provided on the tire equatorial plane CL. On one side in the tire axial direction WD of the center land part 40, the first mediate land part 41 demarcated between the first center main groove 10 and the first shoulder main groove 12 and a first shoulder land part 43 demarcated between the first shoulder main groove 12 and the grounding end E1 on one side in the tire axial direction WD are provided. On the other side in the tire axial direction WD of the center land part 40, a second mediate land part 42 demarcated between the second center main groove 11 and the second shoulder main groove 13 and a second shoulder land part 44 demarcated between the second shoulder main groove 13 and the grounding end E2 on the other side in the tire axial direction WD are provided.

The second mediate land part 42 is formed as ribs continuing in the tire circumferential direction CD. Land parts other than the second mediate land part 42, namely, the center land part 40, the first mediate land part 41, the first shoulder land part 43, and the second shoulder land part 44 include a plurality of lines of blocks divided by lateral grooves extending in the tire axial direction WD and aligning in the tire circumferential direction CD.

In this example, the center land part 40 and the first mediate land part 41 demarcated by the zigzag-shaped first center main groove 10 are characterized by a tread pattern. Structures of the center land part 40 and the first mediate land part 41 will be explained in detail below.

In the center land part 40, a plurality of first lateral grooves 20 that traverse the center land part 40 are provided at intervals in the tire circumferential direction CD. The center land part 40 forms block lines in which blocks (center blocks) demarcated by the plural first lateral grooves 20 and the two center main grooves 10, 11 are aligned in the tire circumferential direction CD.

As shown in FIG. 3 in an enlarged manner, the first lateral groove 20 has a shape bent at a bent part 21. In this example, the first lateral groove 20 is formed in a switchback shape in which the groove is bent in a V-shape in plan view.

The first lateral groove 20 includes one lateral groove part 22 extending from the bent part 21 to communicate with the first center main groove 10 and the other lateral groove part 23 extending from the bent part 21 to communicate with the second center main groove 11. The bent part 21 is placed closer to the first center main groove 10 than the tire equatorial plane CL to make an acute angle.

The one lateral groove part 22 has a first opening 16 that opens to the first groove part 14 of the first center main groove 10 so as to include a connected position between the first groove part 14 and the second groove part 15 in the first center main groove 10, which is provided along the second groove part 15 from the first opening 16.

Specifically, one groove wall 22a of the one lateral groove part 22 is connected to the center land part-side second groove wall 15a demarcating the center land part 40 at the second groove part 15 of the first center main groove 10 and is provided along the center land part-side second groove wall 15a.

The other groove wall 22b of the one lateral groove part 22 is connected to the center land part-side first groove wall 14a demarcating the center land part 40 at the first groove part 14.

In this example, the other groove wall 22b is provided so as to be gradually close to the one groove wall 22a as coming close to the bent part 21, and thus, a groove width of the one lateral groove part 22 gradually narrows from the first opening 16 toward the bent part 21; however, it is also preferable that the other groove wall 22b is provided in parallel to the one groove wall 22a and the one lateral groove part 22 is formed with a fixed groove width. Additionally, a tip of an acute corner part 24 in which the one lateral groove part 22 and the first center main groove 10 make an acute angle may be rounded.

The fact that the one groove wall 22a of the one lateral groove part 22 is provided along the center land part-side second groove wall 15a in the specification is a concept including not only a case where the one groove wall 22a is on the same plane as the center land part-side second groove wall 15a (namely, the one groove wall 22a is parallel to the center land part-side second groove wall 15a) but also a case where an angle 83 made by the one groove wall 22a and the center land part-side second groove wall 15a is 150 degrees or more and 210 degrees or less.

An angle 84 of the one groove wall 22a with respect to the tire circumferential direction CD is preferably smaller than the angle θ1 of the center land part-side second groove wall 15a with respect to the tire circumferential direction CD. Moreover, the angle 83 made by the one groove wall 22a and the center land part-side second groove wall 15a is preferably 150 degrees or more and 180 degrees or less. The angle θ4 of the one groove wall 22a with respect to the tire circumferential direction CD is preferably 10 degrees or more and 80 degrees or less, and the angle θ1 of the center land part-side second groove wall 15a with respect to the tire circumferential direction CD is preferably 10 degrees or more and 80 degrees or less.

The other lateral groove part 23 is a lateral groove portion extending from the bent part 21 in a straight line toward the second center main groove 11, which communicates with the second center main groove 11. The other lateral groove part 23 is a lateral groove portion extending in a direction crossing an extending direction of the one lateral groove part 22, which extends from the bent part 21 to the same side as the one lateral groove part 22 (an upper side in FIG. 3) in the tire circumferential direction CD.

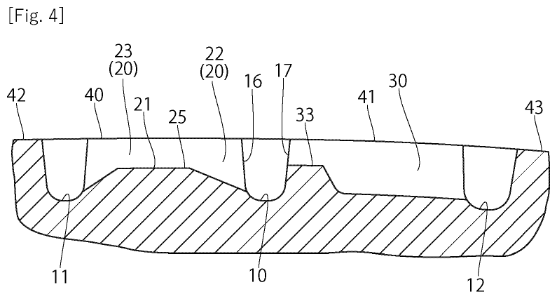

As shown in FIG. 4, the first lateral groove 20 is provided with a bottom-up part 25 formed to be shallow in groove depth by raising the groove bottom. The bottom-up part 25 is formed to be raised highest on the bent part 21 side of the other lateral groove part 23 and to be inclined therefrom so that the groove depth is gradually deepened toward the first center main groove 10 and the second center main groove 11. The bottom-up part 25 connects adjacent blocks by being formed in the entire groove width of the first lateral groove 20.

Furthermore, a plurality of sipes 27 extending in a direction parallel to the other lateral groove part 23 are provided on the center land part 40 at intervals in the tire circumferential direction CD. The sipes 27 are thin grooves with a narrow width in which opening ends to the grounding surface are blocked in a loaded state. The sipes 27 are provided so as to traverse the center land part 40 at places where the first lateral grooves 20 do not exist and also provided on extended lines of the other lateral groove parts 23.

In the first mediate land part 41, a plurality of second lateral grooves 30 and a plurality of third lateral grooves 31 extending in the tire axial direction WD are alternately provided in the tire circumferential direction CD.

The plurality of third lateral grooves 31 extend in the tire axial direction WD from the first shoulder main groove 12 and terminate inside the first mediate land part 41. The plural second lateral grooves 30 are provided between the third lateral grooves 31 which are adjacent in the tire circumferential direction CD so as to allow the first center main groove 10 to communicate with the first shoulder main groove 12 and so as to traverse the first mediate land part 41. The first mediate land part 41 forms a block line in which a plurality of blocks (mediate blocks) demarcated by the plural second lateral grooves 30, the first center main groove 10, and the first shoulder main groove 12 are aligned in the tire circumferential direction CD.

In the second lateral groove 30, a second opening 17 opens to the first groove part 14 of the first center main groove 10 so as to include a connected position between the first groove part 14 and the second groove part 15 in the first center main groove 10. The second opening 17 of the second lateral groove 30 is an opening longer than the first opening 16 of the one lateral groove part 22 in the tire circumferential direction CD. The second lateral groove 30 is provided along the second groove part 15.

Specifically, one groove wall 30a of the second lateral groove 30 is connected to the mediate land part-side second groove wall 15b demarcating the first mediate land part 41 in the second groove part 15 of the first center main groove 10 and is provided along the mediate land part-side second groove wall 15b.

The other groove wall 30b of the second lateral groove 30 is connected to the mediate land part-side first groove wall 14b demarcating the first mediate land part 41 in the first groove part 14 at a position further from the mediate land part-side second groove wall 15b than an extended line L of the center land part-side second groove wall 15a in plan view as shown in FIG. 2 and FIG. 3.

Accordingly, the second opening 17 having a longer opening width along the tire circumferential direction CD than the first opening 16 of the one lateral groove part 22 is provided on the extended line L of the center land part-side second groove wall 15a.

In this example, a tip of an acute corner part 26 in which the second lateral groove 30 and the first center main groove 10 make an acute angle may be rounded.

When the corner part 24 made by the other groove wall 22b of the one lateral groove part 22 and the center land part-side first groove wall 14a is rounded as shown in FIG. 3, a distance from an intersection P of extended lines of the other groove wall 22b and center land part-side first groove wall 14a to the center land part-side second groove wall 15a in the tire circumferential direction CD is an opening width of the first opening 16 along the tire circumferential direction CD. Moreover, when the tip of the corner part 26 made by the other groove wall 30b of the second lateral groove 30 and the mediate land part-side first groove wall 14b is rounded, a distance from an intersection Q of extended lines of the other groove wall 30b and the mediate land part-side first groove wall 14b to the mediate land part-side second groove wall 15b in the tire circumferential direction CD is an opening width of the second opening 17 along the tire circumferential direction CD.

As shown in FIG. 4, a bottom-up part 33 formed to be shallow in groove depth by raising the groove bottom is provided at an end of the second lateral groove 30 on the first center main groove 10 side. The bottom-up part 33 is formed in the entire groove width of the second lateral groove 30. That is, the bottom-up part 33 connects blocks adjacent to each other in the tire circumferential direction CD.

Furthermore, a plurality of sipes 34 extending in a direction parallel to the second lateral grooves 30 and the third lateral grooves 31 are provided in the first mediate land part 41. The sipes 34 are thin grooves with a narrow width in which opening ends to the grounding surface are blocked in a loaded state. The sipes 34 are provided between the second lateral grooves 30 and the third lateral grooves 31 at intervals in the tire circumferential direction CD.

Since the first center main groove 10 has the zigzag shape in the pneumatic tire 1 according to the embodiment, traction performance in a front and rear direction is excellent.

The one groove wall 22a of the one lateral groove part 22 is connected to the center land part-side second groove wall 15a and extends along the center land part-side second groove wall 15a, and the second opening 17 of the second lateral groove 30 is provided on the extension of the center land part-side second groove wall 15a. Therefore, water in the one lateral groove part 22 is smoothly drained to the first center main groove 10 and is easily drained also to the first shoulder main groove 12 from the second opening 17 through the second lateral groove 30 at the time of running on a wet road surface, which improves drainage performance.

Moreover, since the angle θ1 of the center land part-side second groove wall 15a with respect to the tire circumferential direction CD and the angle θ2 of the mediate land part-side second groove wall 15b with respect to the tire circumferential direction CD are different from each other in the embodiment, traction performance is excellent.

In particular, in the case where the angle θ1 of the center land part-side second groove wall 15a with respect to the tire circumferential direction CD is larger than the angle θ2 of the mediate land part-side second groove wall 15b with respect to the tire circumferential direction CD, water in the one lateral groove part 22 is easily introduced to the second lateral groove 30 due to the center land part-side second groove wall 15a at the time of running on the wet road surface, which can improve drainage performance.

The above embodiment is cited as an example and does not intend to limit the scope of the invention. The novel embodiment can be achieved in other various modes, and various omissions, replacements, modifications may occur in a scope not departing from the gist of the invention.

For example, the first center main groove 10 is provided as the zigzag-shaped circumferential direction groove as well as the one lateral groove part 22 is provided in the center land part 40 as the first lateral groove, and the second lateral groove 30 is provided in the first mediate land part 41 in the above embodiment; however, it is also preferable that an arbitrary main groove such as the second center main groove 11, the shoulder main grooves 12 or 13 is provided as the zigzag-shaped circumferential direction groove, and lateral grooves similar to the one lateral groove part 22 and the second lateral groove 30 are provided in respective land parts on one side and the other side in the tire axial direction of the zigzag-shaped circumferential direction groove.

What is claimed is:

1. A pneumatic tire comprising:
a circumferential direction groove extending in a tire circumferential direction;
a first land part provided on one side in a tire axial direction of the circumferential direction groove;
a second land part provided on the other side in the tire axial direction of the circumferential direction groove;
a plurality of first lateral grooves provided in the first land part at intervals in the tire circumferential direction; and
a plurality of second lateral grooves provided in the second land part at intervals in the tire circumferential direction,
wherein the circumferential direction groove extends in a zigzag shape with a first groove part inclined to the tire circumferential direction and a second groove part shorter than the first groove part and inclined to the tire circumferential direction in a reverse direction of the first groove part being aligned alternately,
the first lateral groove has a first opening that opens to the first groove part,
one groove wall of the first lateral groove is connected to a first land part-side second groove wall demarcating the first land part in the second groove part and extending along the first land part-side second groove wall,
the second lateral groove has a second opening that opens to the first groove part and longer than the first opening in the tire circumferential direction,
one groove wall of the second lateral groove is connected to a second land part-side second groove wall demarcating the second land part in the second groove part, and
the second opening is provided on an extension of the first land part-side second groove wall.

2. The pneumatic tire according to claim 1,
wherein an angle of the first land part-side second groove wall with respect to the tire circumferential direction is 10 degrees or more.

3. The pneumatic tire according to claim 1,
wherein an angle of the second land part-side second groove wall with respect to the tire circumferential direction is different from an angle of the first land part-side second groove wall with respect to the tire circumferential direction.

4. The pneumatic tire according to claim 1,
wherein the second land part is arranged on an outer side in the tire axial direction of the first land part.

5. The pneumatic tire according to claim 4,
wherein the first land part is a center land part provided on a tire equatorial plane.

6. The pneumatic tire according to claim 1,
wherein an angle of the one groove wall of the first lateral groove with respect to the tire circumferential direction is smaller than an angle of the first land part-side second groove wall with respect to the tire circumferential direction.

7. The pneumatic tire according to claim 2,
wherein an angle of the second land part-side second groove wall with respect to the tire circumferential direction is different from the angle of the first land part-side second groove wall with respect to the tire circumferential direction.

8. The pneumatic tire according to claim 2,
wherein the second land part is arranged on an outer side in the tire axial direction of the first land part.

9. The pneumatic tire according to claim 3,
wherein the second land part is arranged on an outer side in the tire axial direction of the first land part.

10. The pneumatic tire according to claim 2,
wherein an angle of the one groove wall of the first lateral groove with respect to the tire circumferential direction is smaller than the angle of the first land part-side second groove wall with respect to the tire circumferential direction.

11. The pneumatic tire according to claim 3,
wherein an angle of the one groove wall of the first lateral groove with respect to the tire circumferential direction is smaller than an angle of the first land part-side second groove wall with respect to the tire circumferential direction.

12. The pneumatic tire according to claim 4,
wherein an angle of the one groove wall of the first lateral groove with respect to the tire circumferential direction is smaller than an angle of the first land part-side second groove wall with respect to the tire circumferential direction.

13. The pneumatic tire according to claim 5,
wherein an angle of the one groove wall of the first lateral groove with respect to the tire circumferential direction is smaller than an angle of the first land part-side second groove wall with respect to the tire circumferential direction.
